(19) United States
(12) Patent Application Publication
(10) Pub. No.: US 2015/0058226 A1
(43) Pub. Date: Feb. 26, 2015

(54) TOKEN FOR SHORT RANGE RF TRANSACTION NOTIFICATION

(71) Applicants: Sanjay Gupta, Lakewood, IL (US); Stephen E. Bell, Long Grove, IL (US)

(72) Inventors: Sanjay Gupta, Lakewood, IL (US); Stephen E. Bell, Long Grove, IL (US)

(73) Assignee: MY CITY TAG LLC, Lakewood, IL (US)

(21) Appl. No.: 14/010,212

(22) Filed: Aug. 26, 2013

(51) Int. Cl. G06Q 20/36; G06Q 20/32; G06Q 20/38

(52) U.S. Cl. CPC G06Q 20/367; G06Q 20/38215; G06Q 20/327
USPC 705/67

(57) ABSTRACT

A token has an antenna and a short-range RF receiver to receive wireless receive bursts comprising receive protocol overhead and transaction credentials. A parsing circuit selects a subset of the transaction credentials including a duration of an associated transaction. A credentials memory holds at least the subset of the transaction credentials for the duration of the transaction. A display and/or short-range RF transmitter notifies a transaction notification indicative of the subset of the transaction credentials held in the credentials memory. The short-range RF transmitter transmits wireless transmit bursts in a burst data length shorter than a burst data length of the receive bursts. The wireless receive bursts can have control data and the parsing circuit selects the subset based on instructions in the control data. A display on a vehicle can render the subset of the transaction credentials for the duration of the associated transaction.

### BACKGROUND OF THE INVENTIONS

1. Technical Field

The present inventions relate to the notification of credentials associated with a transaction and, more particularly, relate to a token for the wireless reception of transaction credentials and their subsequent low power presentation.

2. Description of the Related Art

A transaction is an act of exchange between two or more entities. Traditionally, transaction systems have been based on paper credentials that can subsequently be presented as appropriate. More recently, smartphone and other consumer electronics devices have been used to negotiate transactions and present the received credentials—via a display or in some instances over a wireless communication link. Also, RFID tags have been used in some applications to present a unique static tamper resistant identity, programmed at the time of manufacture. The RFID tags are designed to present only on demand their unique static identity. Active RFID tags have been used in some applications which contain their own battery and therefore are able to present their unique static identity on demand or continuously.

### BRIEF DESCRIPTION OF THE DRAWINGS

The present inventions are illustrated by way of example and are not limited by the accompanying figures, in which like references indicate similar elements. Elements in the figures are illustrated for simplicity and clarity and have not necessarily been drawn to scale.

The details of the preferred embodiments will be more readily understood from the following detailed description when read in conjunction with the accompanying drawings wherein:

FIG. 1 illustrates a schematic block diagram of a token according to embodiments of the present inventions;

FIG. 2 illustrates an exemplary time line of data bursts both received and transmitted by a token over a short range RF communication link according to embodiments of the present inventions;

FIG. 3 illustrates a schematic block diagram of a token wherein transaction notifications are communicated in human readable form according to embodiments of the present inventions;

FIG. 4 illustrates a schematic block diagram of a token wherein notifications are transmitted over short range RF according to embodiments of the present inventions;

FIG. 5 illustrates a schematic block diagram of a token wherein notifications are communicated two different ways according to embodiments of the present inventions;

FIG. 6 illustrates one embodiment of a message processor with security verification according to embodiments of the present inventions;

FIG. 7 illustrates one alternate embodiment of a message processor with security verification according to embodiments of the present inventions;

FIG. 8 illustrates an exemplary structure of a wireless receive burst comprising receive protocol overhead and transaction credentials according to embodiments of the present inventions;

FIG. 9 illustrates an exemplary structure of a wireless transmit burst comprising a transaction notification according to embodiments of the present inventions;

FIG. 10 illustrates an exemplary structure of a wireless transmit burst comprising an acknowledgement notification according to embodiments of the present inventions;

FIG. 11 illustrates an exemplary structure of a wireless transmit burst comprising an available notification according to embodiments of the present inventions;

FIG. 12 illustrates a schematic block diagram of an architecture of a transaction consummation and notification system according to embodiments of the present inventions;

FIG. 13 illustrates a message flow diagram associated with a transaction consummation and notification system according to embodiments of the present inventions;

FIG. 14 illustrates a flow diagram of states associated with a token according to embodiments of the present inventions;

FIG. 15 illustrates a perspective view of an exemplary construction including housing and display of a token for a municipal parking system according to embodiments of the present inventions; and

FIG. 16 illustrates a view of an exemplary use of a token with a vehicle according to alternative embodiments of the present inventions.

### DETAILED DESCRIPTION OF THE PREFERRED EMBODIMENTS

The inventions facilitate and present credentials associated with a transaction. The transactions are in and between systems where an entity negotiates with another entity for at least one resource, receives credentials to document the transaction executed, and must present some or all of the received credentials as needed. Examples of transaction systems include parking sessions both public and private, transportation ticket & access systems (for example airline boarding passes or rail tickets), identity and access control systems, and transactions associated with payment of municipal and state permit taxes for vehicles.

These and other transaction systems have historically been based on paper credentials or a physical tokens which can subsequently be presented as appropriate. More recently, smartphone and other consumer electronics devices have been used to negotiate transactions and present the received credentials—either via a display or in some instances over a wireless communication link. To address the issues of cost and power consumption, RFID tags have been used in some applications to present a unique static tamper resistant identity, programmed at the time of manufacture. The RFID tags are designed to present only on demand their unique static identity. Active RFID tags have been used in some applications that contain their own battery and therefore are able to present their unique static identity continuously.

The present invention is a token optimized for receiving one or more transaction credentials via a short range wireless communication link and the notification of the received transaction credentials via one or more methods. The token must be optimized for low power to avoid the need for charging and to enable it to continuously receive transaction credentials and continuously present notifications. Methods for notification credentials to be supported include for example visually in human form via a display that is optimized for low power consumption and a short range wireless communication link optimized for low power consumption. Furthermore, the life of the token must be significantly longer than the duration of any single transaction session. To be effective within or between any system the token must operate across multiple transaction types, be able to receive and notify multiple credentials simultaneously, and handle multiple governing entities each with its own unique credentials format and structure and the form of notification required of the same transaction type. For example, in a public parking system embodiment, different cities may process transactions differently and the credentials issued take different forms with differences in which parts of the received credentials must be notified. In pay-by-display systems, some municipalities may require display of start time, end time, date and total payment as well as space number while others may require only a unique serial number assigned to the transaction. This would be different again in a reservation based parking systems, where only an end-time may be relevant which indicates when the reservation for the parking spot is set to expire and therefore the notification may include only the end time associated with the transaction. Additionally, the token must be capable of supporting the regulations for different demographics, for example a parking regulatory system may provide special privileges for handicapped and senior citizens, expectant mothers, government vehicles, residents of a specified zone and so on and the token must take into account these endorsements and be designed to present these accordingly. Additionally, the token must be designed to be assigned and re assigned to an individual or an entity and shall support multiple transactions during its lifetime.

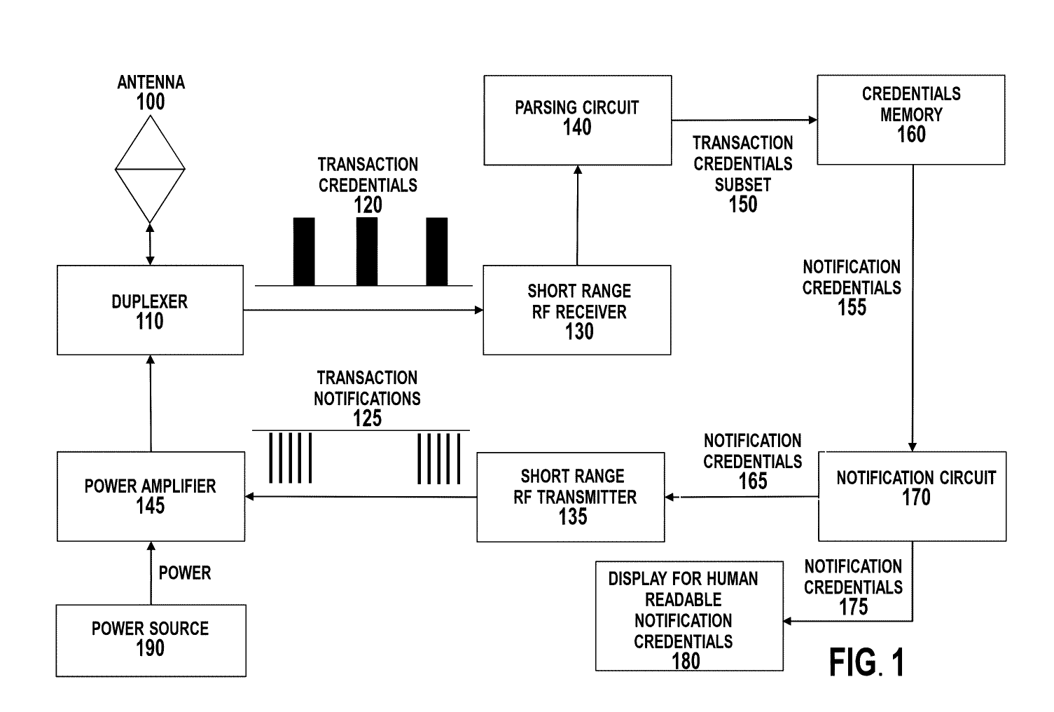

FIG. 1 illustrates a schematic block diagram of a token according to embodiments of the present inventions. The token receives and communicates credentials associated with a transaction, henceforth referred to as transaction credentials 120. The token has an antenna 100, which is coupled to a duplexer 110. The duplexer 110 allows both receive and transmit data over a single RF link. A single antenna in some embodiments may be used by multiple wireless technologies and that the duplexer may be integrated with other circuitry.

The duplexer is coupled to a short range RF receiver 130. The short range RF receiver 130 takes the received digital stream from the duplexer 110 and converts it into digital data for further processing. The short range RF protocol is one with a typical range of about 100 meters. Examples of such short range RF protocols include IEEE 802.11 WiFi, Bluetooth, Bluetooth Low Energy (BLE), Zigbee, and Z-wave. The short range RF protocol receives and transmits data in bursts. Bursts are short periods of receiving or transmitting data at the peak data rate followed by a period of no receive or transmit activity. The peak data rates can be as high as 1000 kbps allowing data to be transmitted with low latency. The peak current consumption for these short range technologies can be lower than 30 mA and the average current consumption is typically less than 1 mA and in some cases less than 50 microamps. The received digital data contains the bursts associated with the short range RF protocol. The received bursts primarily contain the credentials associated with a transaction, henceforth referred to as transaction credentials 120. In addition to the transaction credentials 120, the received bursts may contain for example data necessary to manage short range RF protocol and provisioning data for the token. Transaction credentials are typically generated by an owner entity. An owner entity is the authority that is empowered to receive transaction requests for one or more resources and approve or deny the received requests. For example, municipalities or a delegate would be the owner entity for a public parking session request.

Furthermore, the duplexer 110 is coupled to a short range RF transmitter 135 via a power amplifier 145. The short range RF transmitter 135 receives bursts of data to be transmitted and converts it to a stream of digital data and provides it to the power amplifier 145. The messages to be transmitted typically include but are not limited to the notifications and data needed for management of the short range RF link. The power amplifier 145 is further coupled to a power source 190 to provide the power needed to provide the amplification. The power amplifier 145 amplifies the signal to be transmitted so that it can be transmitted over the short range RF link. Note that in an implementation, the power amplifier function may be integrated with other electronic circuits. Note that transaction credentials 120 may be received during the transmission of a notification.

The parsing circuit 140 generates one or more subsets of the transaction credentials received, henceforth referred to as transaction credential subset(s) 150, for notification purposes. The transaction credential subset(s) 150 are then stored in credentials memory 160. One subset is generated for each notification mechanism to be used. For example, if notifications are to be performed via short range RF and visually in human readable form, then two subsets are generated—one containing data for notifications via short range RF and another subset for visual notifications that are human readable.

The transaction credential subsets 150 generated by the parsing circuit 140 contain two parts: (i) notification credentials—which contains the data that is communicated and (ii) the notification credentials control data that contains information relevant to decide which part of the notification data must be communicated and when. For example, notification credentials control data may include information specific to the owner entity that generated the transaction credentials and their owner entity specific requirements for notifications. Note that the token can be used across multiple entities each having its own requirements about what is required in the notifications. The notification circuit may determine when and for how long the notification credentials are to be communicated using (i) the data contained in the notification credentials control data or (ii) data stored in the credentials memory 160 that may have been stored at the time of initial provisioning of the device. Further, this data may be updated from time to time by the owner entity.

The notification circuit 170 reads the notification credentials 155 from credentials memory 160 and conveys them to circuitry appropriate for making the notifications. For example, the notification credentials 175 may be communicated visually via a display or one or more light emitting diode (LEDs) such that the notifications credentials are human readable 180. Alternatively, another set of notification credentials 165 may be communicated via the short range RF transmitter 135.

The transaction credentials 120 contain context data relevant for the transaction and may include one or more, but not limited to, of the following: identity of the requesting entity of the transaction; identities of the applicable assets associated with the requesting entity (for example a vehicle), identity of the associated token, the identity of the resource(s) being requested, if applicable, start time, end time and duration of the request, and transaction specific parameters (for example a reservation for a future date/time), a unique transaction identifier, notification methods and frequency, applicable image, audio, video, and data for notification purposes (for example, if a display is used for communication of notification of transaction credentials, an image may be included).

Notification credentials 155 may include, but are not limited to, the following—transaction identity (typically a unique identifier such as a serial number), transaction specific parameters, such as the duration of the transaction, transaction execution time, transaction start time, location, cost of the transaction, audio, video and multimedia data depending on the intended notification mechanism. Furthermore, the notification credentials may include information on when the notifications must be made—for example, the duration and the frequency of communication of the notification credentials, sensor data that may be used to enable or disable notifications.

It must be noted that the received data stream of a transaction credential 120 is of a bursty nature, i.e., a large amount of data is received in a compressed time and it is followed by a long time interval of no received data. Further, the time between two received transaction credentials 120 is much larger than the time interval between two successive transaction notification transmissions 125.

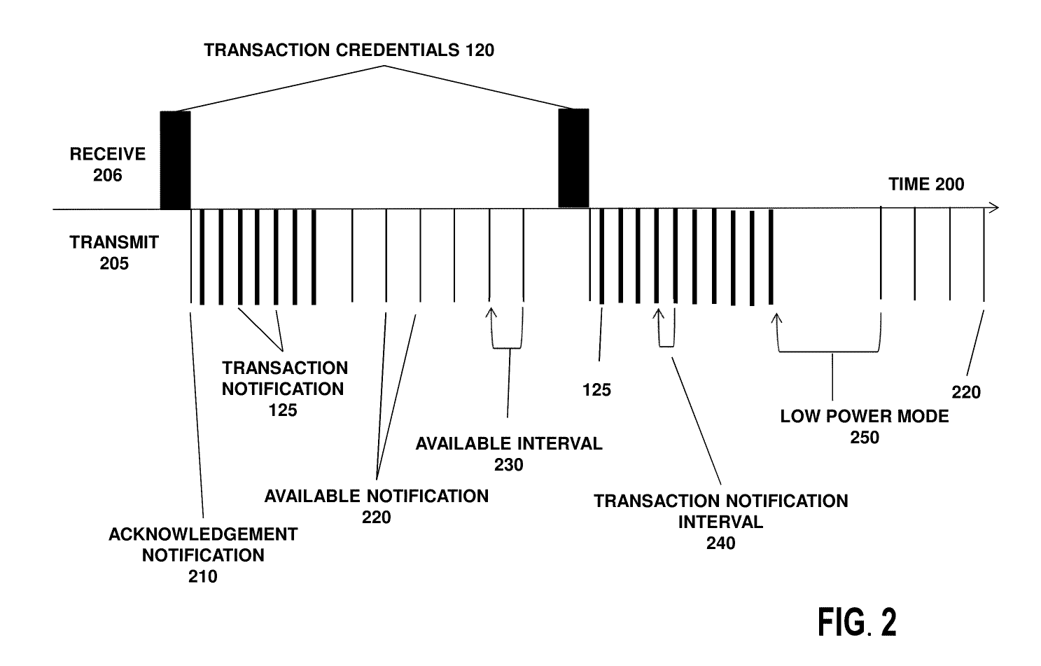

FIG. 2 illustrates an exemplary time line of data bursts both received and transmitted by a token over a short range RF communication link according to embodiments of the present inventions. Note that the horizontal axis represents time 200 and increases from left to right. The bursts received 206 by the token are shown above the time axis 200. The bursts transmitted 205 by the token are shown below the time axis 200. The bursts received 206 by the token primarily contain the transaction credentials 120. It must be noted that additional bursts for operation and management of the short-range RF communication link or the token itself may be received by the token. The bursts transmitted 205 by the token primarily include notifications. Additionally, bursts for management of the short range RF communication link and the token itself may be transmitted.

On receiving the transaction credentials, the token may generate an acknowledgement notification 210 to convey the successful reception of the said transaction credential. Subsequently, the token generates and schedules the transmission of the generated transaction notifications 125. Note that a transaction notification 125 may be transmitted more than once. The interval between two successive transmissions of a transaction notification 125 is referred to as the transaction notification interval 240. The duration of the transaction notification interval and the number of transmissions of the credential notification 125 is determined by the token taking into account the information contained in the transaction credentials 120.

During periods when no notifications are being transmitted, the token may decide to transmit an available notification 220. The available notification 220 provides a “heart beat” and notifies its ability to receive transaction credentials 120. Note that available notification 220 may be piggybacked on a transaction notification 125, acknowledgement notification 210, or another message to reduce the data transmitted and therefore conserve power.

The duration between two consecutive available notifications 220 is referred to as available interval 230. Note that transaction notification interval 240 must be smaller than or equal to the available interval 230. Further, note that in most implementations, the time interval between two successive receptions of the transaction credentials is expected to be larger than the available interval 240.

In addition, to conserve power, the token may enter into a low power mode 250 periodically. During low power mode 250, the device may not receive transaction credentials and further one or more notification transmissions may be suspended or eliminated. The low power mode interval will typically be a multiple of the available interval Immediately prior to entering low power mode the token may transmit a notification. The token exits the low power mode by transmitting a notification. Further sensors located on the token may assist the token in deciding when to enter or exit low power mode. Sensors to be included may comprise a real time clock, accelerometer, compass, etc. For example, low power mode may be active for a time duration depending on the real time clock (for instance between midnight and 4 am). In another embodiment, the low power mode may be initiated by the clock but terminated by the accelerometer.

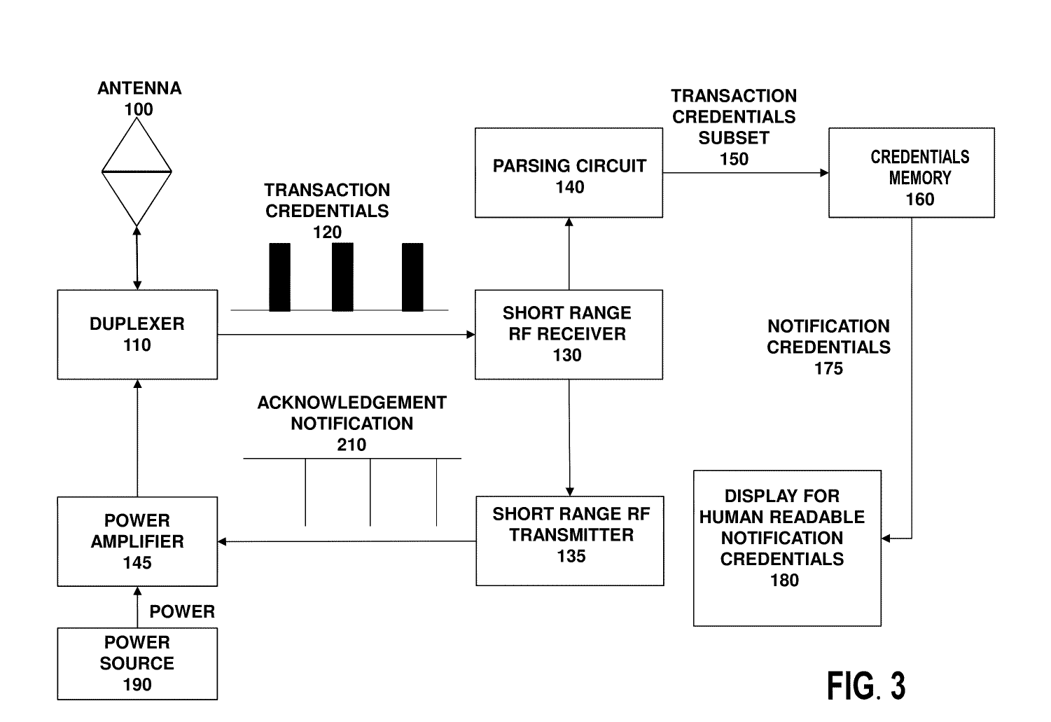

FIG. 3 illustrates a schematic block diagram of a token wherein transaction notifications are communicated in human readable form according to embodiments of the present inventions. The token receives and communicates credentials associated with a transaction, henceforth referred to as “transaction credentials” 120. The token has an antenna 100, which is coupled to a duplexer 110. The duplexer 110 allows both receive and transmit data over a single (duplex/paired spectrum or single frequency) RF link. The duplexer is coupled to a short range RF receiver 130. The short range RF receiver 130 takes the received digital stream from the duplexer 110 and converts it into digital data for further processing. Furthermore, the duplexer 110 is coupled to a short range RF transmitter 135 via a power amplifier 145. The short range RF transmitter 135 receives bursts of data to be transmitted and converts it to a stream of digital data and provides it power amplifier 145.

The parsing circuit 140 generates a transaction credential subset for notification in human readable form via a display. The transaction credential subset is then stored in credentials memory 160 which is coupled to the display for human readable notification of transaction credentials 180. It is important to note that the display is based on a low power technology. An example of such a technology is e-ink, where the power consumption due to the display is essentially zero when the image on the display is static. Note that as before, on receiving transaction credentials 120, the token transmits an acknowledgement notification 210 to indicate successful reception of transaction credentials 120.

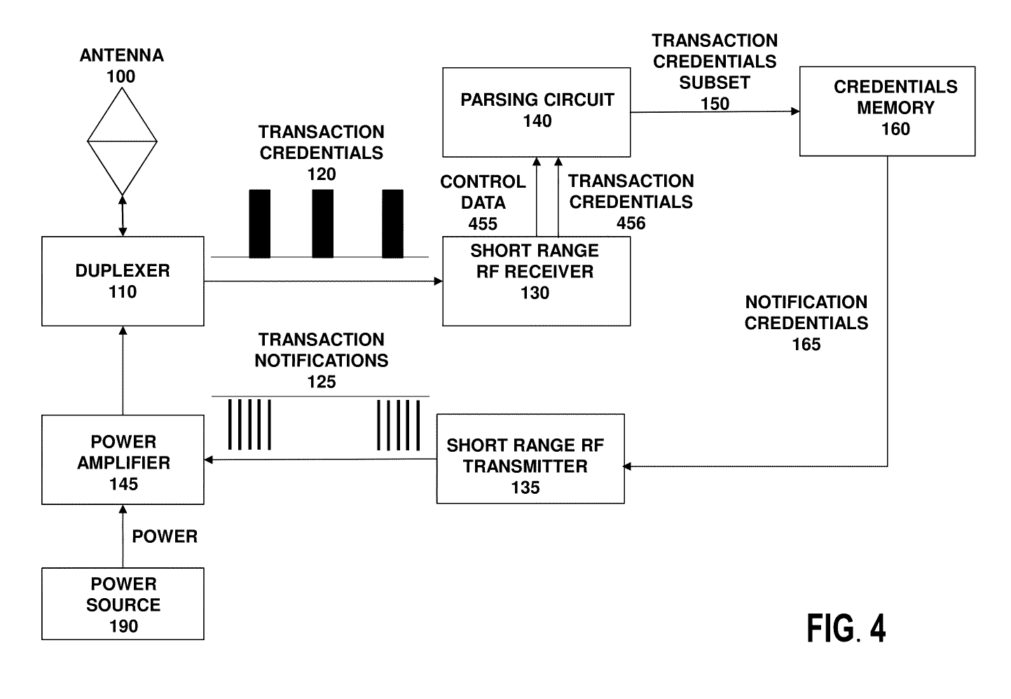

FIG. 4 illustrates a schematic block diagram of a token wherein the token receives and communicates credentials associated with a transaction, henceforth referred to as “transaction credentials” 120 and transmits transaction notifications 125 via short range RF. The token has an antenna 100, which is coupled to a duplexer 110. The duplexer 110 allows both receive and transmit of data over a single RF link. The duplexer is coupled to a short range RF receiver 130. The short range RF receiver 130 takes the received digital stream from the duplexer 110 and converts it into digital data for further processing. Furthermore, the duplexer 110 is coupled to a short range RF transmitter 135 via a power amplifier 145. The short range RF transmitter 135 receives bursts of data to be transmitted and converts it to a stream of digital data and provides it to the power amplifier 145. The short range RF receiver sends the received transaction credentials 456 and the associated control data 455 to the parsing circuit 140. The control data 455 contains data that must be used by the parsing circuit 140 to create the transaction credential subset 150. For example, the control data may contain information on which elements of the received transactions must be contained in the transaction credential subset 150 and finally the notification credentials 165. Control data is dependent on the owner entity and is therefore provided by the owner entity.

Note that the parsing circuit 140 generates one transaction credential subset 150 containing the associated transaction credentials control data 150 for notification via the short range RF communication link. The transaction credential subset 150 is then stored in credentials memory 160. The short range RF transmitter 135 reads the notification credentials 165 from credentials memory 160 and transmits the transaction notifications 125. The transaction credentials subset may further contain notification credentials control data to direct the scheduling of the transaction notification 125 transmissions. Note that as before, on receiving transaction credentials 120, the token transmits an acknowledgement notification 210 to indicate successful reception of transaction credentials 120.

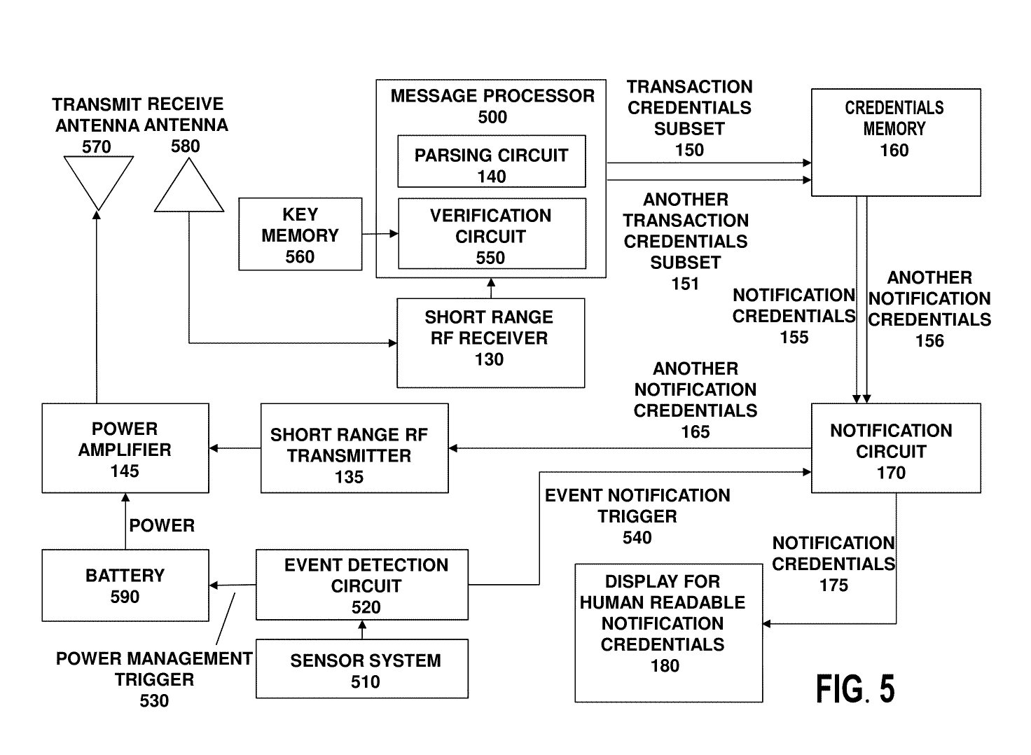

FIG. 5 illustrates a schematic block diagram of a token wherein notifications are communicated two different ways according to embodiments of the present inventions. In this invention, a battery 590 is used as the power source. Further, the message processor 500 includes an additional step of verification of the received transaction credentials via the verification circuit 550. The process of verification may involve using a secret key previously provisioned on the token and stored in key memory 560. The verification process may include one of more of the following steps: (i) authenticating the integrity of the received credentials (for example via an included checksum and optionally the contents of key memory 560), (ii) authenticity of the sender, (iii) verifying that identity of the prescribed destination “token” matches its own, (iv) decrypting using the contents of the secret key memory 560 the received bursts to extract the transaction credentials. The message processor generates two transaction credentials subsets—namely transaction credentials subset 150 and another transaction credentials subset 151. Transaction credentials subset 150 and another transaction credentials subset 151 are stored in the coupled credentials memory 160. The notification credentials 155, and subsequently notification credentials 175 are generated from the transaction credentials subset 150 and are notified via the display for human readable notification credentials 180. Similarly, another transaction credentials subset 151 is used to generate the other notification credentials 156 and subsequently other notification credentials 165. The other notification credentials 165 are transmitted by the short range RF transmitter 135.

Also note that in an embodiment of the invention, the separate short range RF communication links may be split for receive and transmit sides as illustrated in FIG. 5. Herein, receive antenna 580 is dedicated to receive bursts destined for the token and the transmit antenna 570 is dedicated for notification transmissions from the token. For example, the short range RF receiver 130 communication link may be based on Bluetooth technology and Near Field communication (NFC) technology may be utilized for the short range RF transmitter 135 used for transmission of notifications.

Further, one or more sensors, for example, an accelerometer, a real-time clock, collectively referred to as a sensor system 510, monitor the status of the token and provide the raw sensor data to the event detection circuit 520. The event detection circuit 520 uses the data provided by the event detection system 520 to detect one or more pre-defined events. For example, the event detection system 520 would determine using the data provided by an accelerometer if the vehicle in which the token has been installed is running, in motion, or parked. On detecting a pre-defined event, the event detection system 520 generates one or more of the following triggers: (i) an event notification trigger 540, (ii) a power management trigger 530. The power management trigger 530 is used to conserve power by instructing the token to move in and out of low power modes. The event notification trigger 540 may be used to initiate or terminate transmission of notification credentials 165 and 175 or change the notification interval 240. For example, in an embodiment of the invention for a parking transaction, the sensors detect if a car is moving or parked and may terminate an ongoing series of notifications or initiate a series of notifications, respectively. Furthermore, the sensors may be used to provide user interface. For example, an accelerometer gesture may be used to switch the token on or off or direct it to enter a state where it can enter into a secure communication relationship with another device or remove a secure communication relationship with a device. In another embodiment, for instance in a reservation based parking system, the sensor system 510 may be used to detect that the parking resource which had been reserved earlier, is now in use and the parking session must be started and therefore the credential notification must start. Examples of sensors in the sensor system 510 include, but are not limited to accelerometers, gyroscopes, light sensor, and magnetometer.

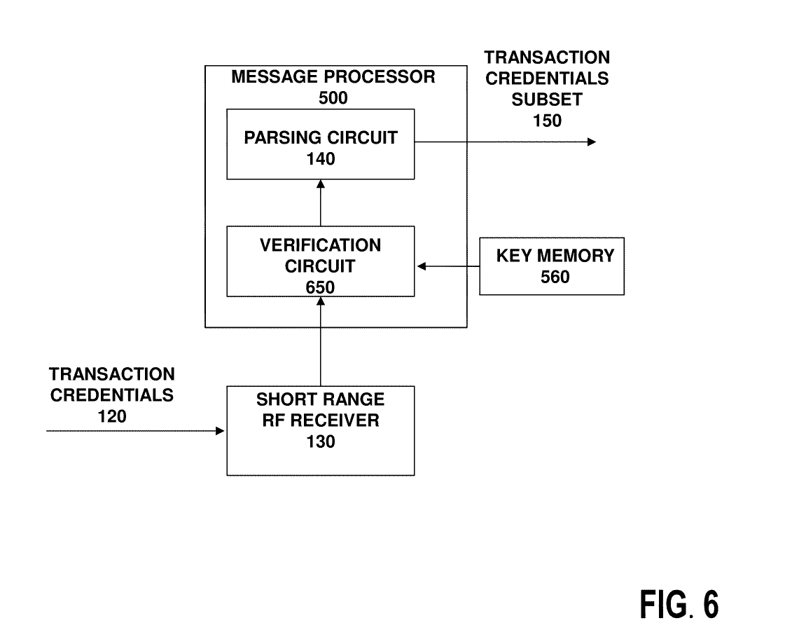

FIG. 6 illustrates one embodiment of a message processor 500 with security verification according to embodiments of the present inventions. In said embodiment, the transaction credentials 120 received by the short range RF receiver are routed to the coupled verification circuit 650. On successfully verifying as per the process described previously, the said transaction credentials are provided to the parsing circuit 140. The parsing circuit 140 then generates the transaction credentials subsets 150 for notification purposes.

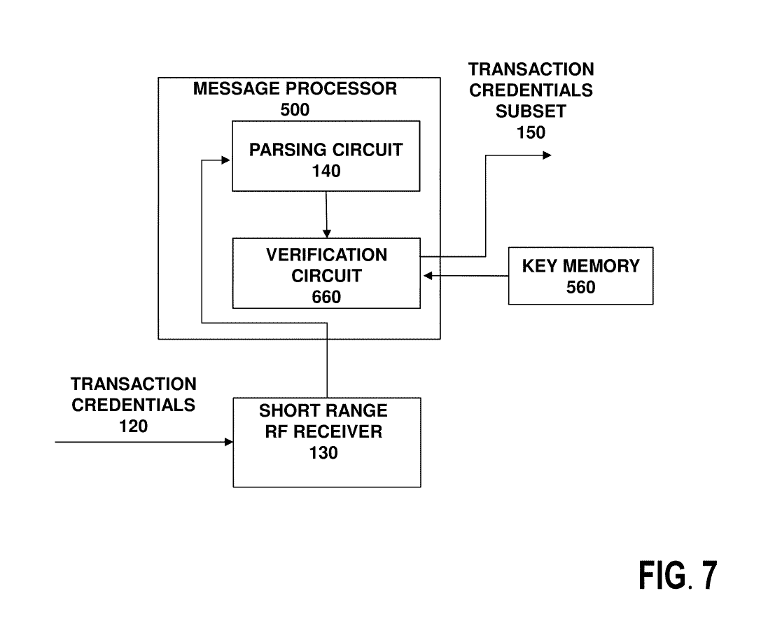

FIG. 7 illustrates one alternate embodiment of a message processor 500 with security verification according to embodiments of the present inventions. In this embodiment, the transaction credentials are initially provided to the parsing circuit 140 that identifies and delineates the components of the received transaction credentials 120 and provides them to the verification circuit 660. The verification circuit 660 verifies each of the said components of the received transaction credentials 120 and then communicates one or more of the transaction credentials subsets 150 for notification purposes.

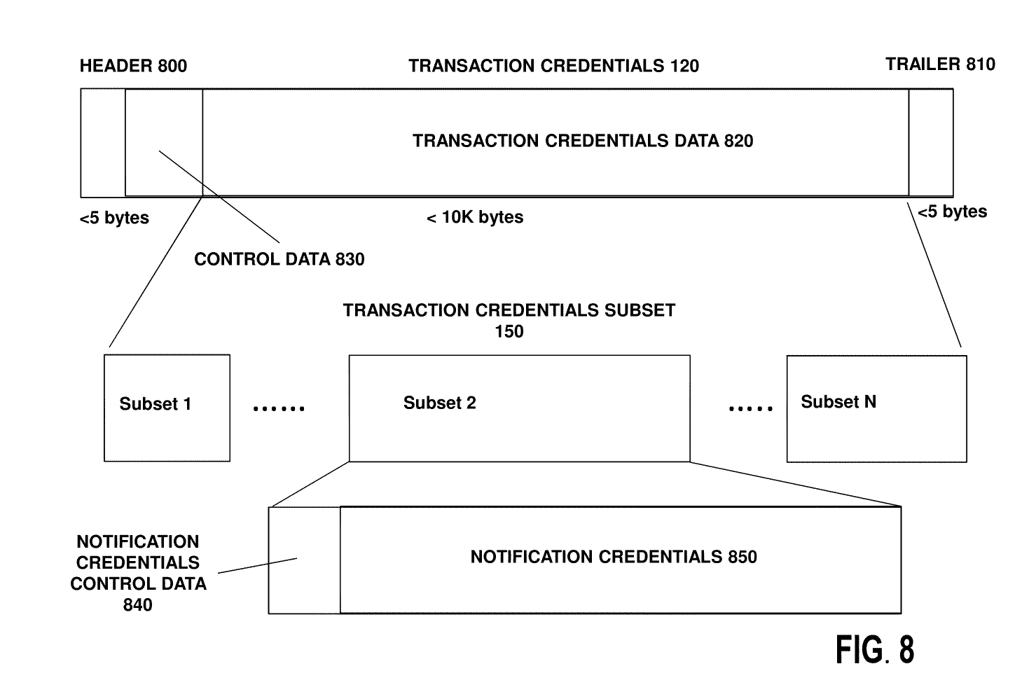

FIG. 8 illustrates an exemplary structure of a wireless receive burst comprising receive protocol overhead and transaction credentials according to embodiments of the present inventions. The transaction credential burst contains a header 800 and trailer 810 required per the short range RF protocol and is referred to as protocol overhead. Note that the header and trailer in notifications contain at least the addresses of the source and the destination as well as a checksum to ensure error free communication. Further, as explained earlier the transaction credentials may be encrypted to ensure that they can be received and processed only by a specified token. The main body of the transaction credentials 120 includes the transaction credentials data 820 and the control data 830. The transaction credentials data 820 contains the key parameters associated with a transaction which includes at least a unique transaction identifier, parameters for notifications, identity of resources associated with the transaction, identity of the requestor, security keys that may be required for verification by the token. The control data 830 contains information to help the parsing circuit generate the transaction credentials subsets 150. The transaction credentials subsets 150 include one transaction credentials subset for each of the unique methods by which the notifications must be communicated. Each of the subsets of the transaction credentials subset 150 contains two separate parts: (i) the notification credentials 850 and (ii) the notification credentials control data 840 as explained earlier. The notification credentials control data contains information about when and how often the transaction notifications must be communicated.

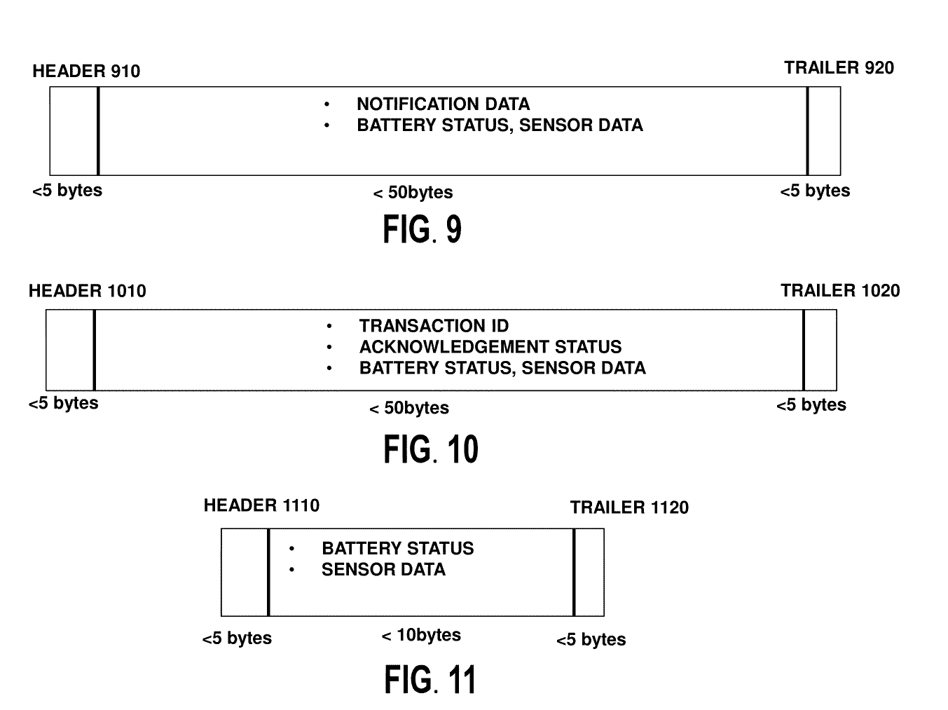

FIG. 9 illustrates an exemplary structure of a wireless transmit burst comprising a transaction notification according to embodiments of the present inventions. Header 910 and trailer 920 are required per the short range RF protocol and are together referred to as protocol overhead. Note that the header and trailer in notifications contain at least the addresses of the source and the destination and a checksum to ensure error free communication. The transaction notification includes parts of the notification credentials, for example, transaction identity (typically a unique identifier such as a serial number), transaction specific parameters, such as the duration of the transaction, transaction execution time, transaction start time, location, and cost of the transaction. It may optionally include the status of the power source (for example a battery), current time and data, and data from the sensor system. The transaction notification is optimized for low power and therefore is expected to be small—say less than 50 bytes of payload with an additional 10 bytes for protocol overhead. Furthermore, in order to reduce power consumption the number of times transaction notification is transmitted is minimized within the allowable constraints.

FIG. 10 illustrates an exemplary structure of a wireless transmit burst comprising an acknowledgement notification according to embodiments of the present inventions. Header 1010 and trailer 1020 are required per the short range RF protocol. Note that the header and trailer in notifications contain at least the addresses of the source and the destination and a checksum to ensure error free communication. The acknowledgement notification message includes a unique identifier included in the transaction credentials message being acknowledged, the acknowledgement status (to indicate successful reception of the transaction credentials or otherwise). Further, it may include option data such as status of the power source, current date and time, and sensor data.

FIG. 11 illustrates an exemplary structure of a wireless transmit burst comprising an available notification according to embodiments of the present inventions. The data transmitted by the short-range RF transmitter 135 comprises the available notification of FIG. 11 sent when the short-range RF receiver 130 is available. Header 1110 and trailer 1120 are required per the short range RF protocol and are together referred to as protocol overhead. Note that the header and trailer in notifications contain at least the addresses of the source and the destination and a checksum to ensure error free communication. The available notifications are expected to be the most frequent notifications and therefore for power optimization purposes are engineered to be the shortest, typically less than 10 bytes and less than 5 bytes for a header and a footer. The available notifications may include battery status, current date and time and relevant sensor data.

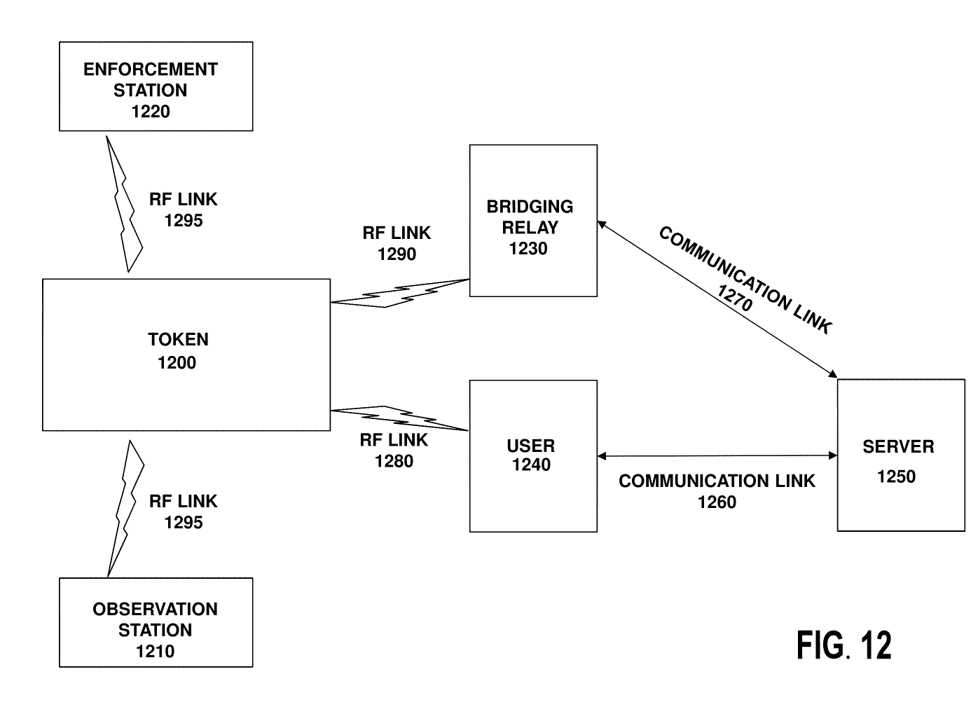

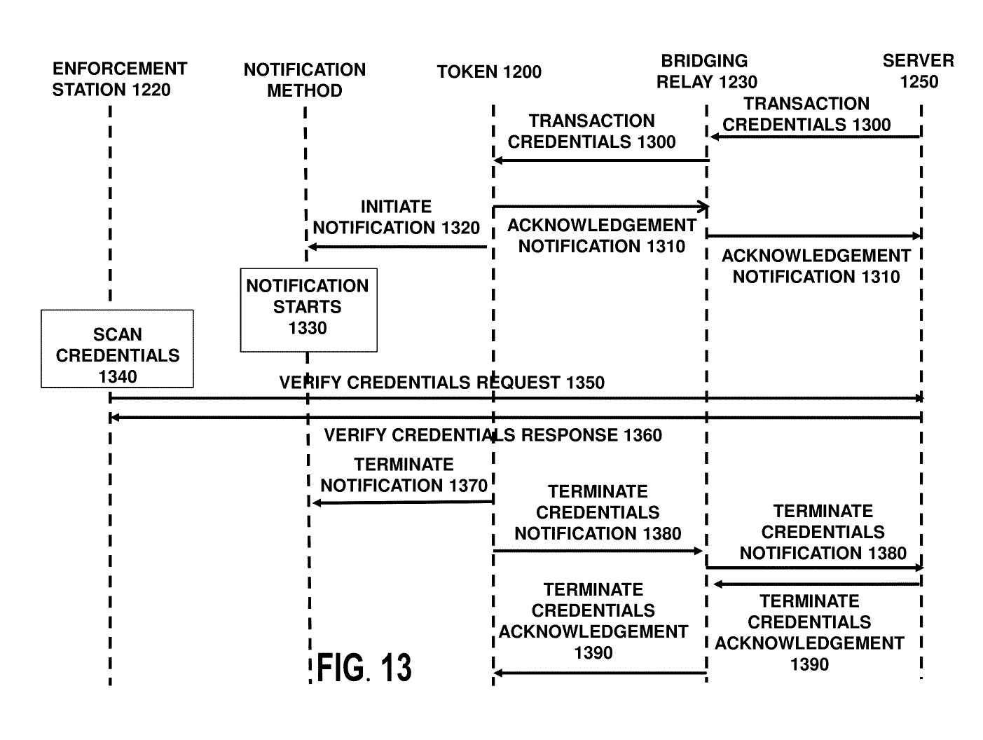

FIG. 12 illustrates a schematic block diagram for an architecture of a transaction consummation and notification system according to embodiments of the present inventions. The user 1240 initiates the request for a transaction and sends a message to server 1250 using the communication link 1260. The communication link 1260 may be based for example on one of the following: an Internet connection, a messaging system such as Short Messaging Service (SMS) as defined in cellular networks, or a voice call. In this case, the user 1240 may send a transaction request to server 1250 via a dedicated web application or a mobile browser coupled to the communication link 1260.

The transaction request contains the details of the transaction requested and may include either explicitly or implicitly (but not limited to) the identity of the token 1200, the resource(s) requested including the start time and the duration or end time, the identity of user 1240, identity of any associated objects, payment amount, payment method, credentials associated with the payment method, and an identifier associated with the transaction request, such as a serial number. The server 1250 receives the transaction request and either accepts or denies the transaction request. The transaction request is accepted based on one or more of the following criteria: availability of the requested resources, availability of funds in user 1240 account or credit availability, constraints established by the owner of the resource requested, etc. Upon acceptance of a transaction request the server 1250 generates a set of transaction credentials, optionally encrypts them, and sends them to the token 1200 identified in the transaction request.

The transaction credentials may be routed through a bridging relay 1230 by the server via short range RF. In this case, communication link 1270 is used to communicate the transaction credentials to the bridging relay 1230, which in turns forwards the received transaction credentials to the token via the short range RF link 1190. The communication link 1270 may be based on Internet protocols or an appropriate wide area communication technology. Note that the bridging relay 1230 allows bursts to be routed to and from the token to other entities in the system via short range RF. This allows the token implementation to maintain low power consumption without sacrificing connectivity.

The RF links 1290, 1280, and 1295 may use the same or different short range RF communication technology optimized for low power operation such as Bluetooth, Bluetooth low energy (BLE), Zigbee, Z-wave and other similar technologies.

Further, the server 1250 may provide an interface for the user and enforcement agencies to retrieve appropriate historical records of generated transaction credentials. Additionally, the server 1250 may be optionally coupled to appropriate information services that may be of interest to user 1240.

The token 1200 after receiving the transaction credential generates one or more set of credential notification for communication. Observation stations 1210 and enforcement stations 1220 via the RF link 1295 may receive the credential notification. In an alternative embodiment, the notification of credentials may happen via a display in human readable format. The enforcement station 1220 uses the received credential notification to determine the validity of the transaction and permission to use the associated resource. The enforcement station 1220 may issue a citation if the credentials are not valid. The enforcement station 1220 may optionally communicate with server 1250 to validate the credentials.

FIG. 13 illustrates a message flow diagram associated with a transaction consummation and notification system according to embodiments of the present inventions. The user 1240 typically initiates a transaction request and communicates it to the server. In an alternative embodiment, the token may generate the transaction request. In another embodiment, a software client running on behalf of the user may initiate the transaction request.

If the transaction request from the user 1240 can be accepted, the server 1250 creates a transaction credentials 1300 message and communicates it to the token via one or more bridging relay 1230. The process of determining if the transaction request can be accepted may involve further the step of communicating with 3^{rd} party information servers coupled to server. The third party information servers may optionally include information services maintained by the owner of the requested resource, government policies, weather conditions, etc. A unique serial number is assigned to every transaction and is included in the transaction credentials 1300 message. The transaction credentials 1300 message may also optionally contain the identity of the resource assigned including a start time and end-time (or alternatively the duration), and any additional informational message as deemed appropriate by the server. Furthermore, the transaction credentials contain data to direct the token, which parts of the transaction credentials, when, and for how long must be notified by the token.

When the transaction credentials 1300 are routed to the token via a bridging relay 1230, the bridging relay 1230 sends the transaction credentials 1300 to the requested token 1200 via the short range RF link. The step of sending the transaction credentials 1300 by the bridging relay 1230 may include the step of converting the received data into a format consistent with that required for transmission over the short range RF communication protocol.

On successfully receiving the transaction credentials 1300, the token 1200 communicates its successful reception to the bridging relay via the acknowledgement notification 1310. On receiving the said acknowledgement notification 1310 the bridging relay 1230 forwards the acknowledgement notification 1310 to the server 1250 to indicate that the transaction credentials 1300 have been successfully delivered to the token 1200.

The token 1200 verifies the transaction credentials 1300 and creates the notification credentials and as per the directions initiates periodic transmission of the notifications via initiate notifications 1320. Note the said directions may be partly provisioned in the token and partly may be delivered as part of the transaction credentials. Once the token has successfully initiated the transmissions of the credential notifications, the said credential notifications may be received by an enforcement station 1220. Enforcement station 1220 may optionally decide to validate the received credential notification by sending a verify credential request message 1350 to the server. The server on receiving a verify credential request 1350 responds by sending a verify credential response 1360. The verify credential response 1360 contains information to inform the enforcement station if the transaction identified in the verify transaction credential request 1350 is valid.

Termination of transmission of credential notifications may be done implicitly or explicitly. For example, if the transaction credentials provided access to a fixed predetermined start time and time duration then an implicit approach is used and the transmission of credential notifications is terminated when the transaction duration has ended. However, if no end time or time duration was specified or alternatively the transaction must be terminated earlier than completion of the specified duration then an explicit approach must be used. In the explicit approach, the token terminates the transmission of the notification credentials and directs the server to terminate the transaction by sending a terminate credentials notification 1380. Note that the terminate credentials notification 1380 may be routed to the server 1250 via a bridging relay 1230 and that the server 1250 responds to a terminate credentials notification 1380 with a terminate credentials acknowledgement 1390 also via a bridging relay 1230.

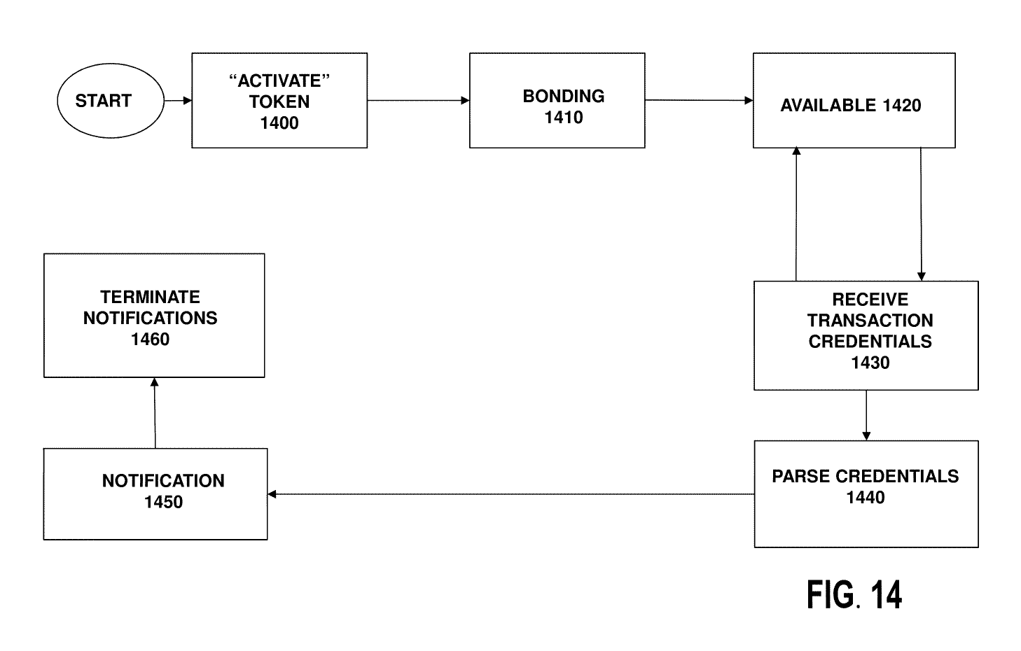

FIG. 14 illustrates a flow diagram of states associated with a token according to embodiments of the present inventions. On activating the token for the first time it enters the activate token state 1400, the said token prepares itself for establishing a secure communication relationship with a peer device by entering the bonding state 1410. The token only accepts transaction credentials from a device with which it has established a secure communication relationship. For example, if the Low power RF technology used is Bluetooth Low Energy (BLE), alternatively also known as Bluetooth 4.0, the process of establishing a secure relation involves the “Pairing”. It is important to note that one or more devices are provisioned in the token as having a secure communication relationship prior to it being activated by the user or alternatively provisioned as part of a device update procedure. Once the token has bonded with at least one device, it is ready to receive transaction credentials 120 and it enters the available state 1420. In this state, the token may indicate its availability to receive transaction credentials by periodically transmitting available notifications 220.

The token enters receive transaction credentials state 1430 when it starts to receive transaction credentials. On successfully receiving transaction credentials, the token acknowledges successful reception of the notification 210 and is ready to receive additional transaction credentials and transitions to the parse credentials state 1440. In the parse credentials 1440 state it generates the subsets of the received transaction credentials 150 and optionally stores them in a coupled credentials memory 160 and transitions to the notification state 1450. In the notification state the token transmits credential notifications 165 and 175 as per the directions provisioned in the token and those received as part of the transaction credentials. Note that the token enters the terminate notification state 1460 when the periodic transmissions of the notifications must be ceased. The transaction credentials contain directions about when the credentials notifications must be stopped. In an alternative embodiment, such directions may be augmented with information provisioned in the token. In another alternative embodiment, the sensor system 510 may trigger the transitions to notification state 1450 and terminate notification state 1460.

It must be noted that more than one notification credentials may be communicated simultaneously. For example, if an e-ink display is used, it may be segmented logically and different credentials may be rendered on non-overlapping parts of the display. Similarly, if a short range RF link is used for communication of notification credentials, the notification credentials may be multiplexed (either in time, frequency or code domain) for simultaneous communication. Furthermore, the token can convey zero, one or more subsets of the received transaction credentials together.

We now summarize some of the power saving inventions that may be implemented to ensure maximum usable life of the token is achieved. These include: (i) reducing the amount of data that must be transmitted as part of the various notifications messages via short range RF; (ii) reduction in frequency of the notification messages without compromising the user experience or functionality of the system; (iii) Low energy display, for example e-ink display, which has a persistent display and does not require energy consumption to maintain a static image on the display; (iv) use of sensors to transition the device in and out of power saving modes. Furthermore, to optimize power consumption of the token, the system is designed to reduce the size of transmissions that include the optional “Alive” messages and notification credentials when they are transmitted over short range RF communication technology. For example, the available notifications will typically be less than 20 bytes and the credential notifications transmitted over short range RF will be less than 50 bytes allowing a token to have a useful life of multiple years on a single coin cell battery.

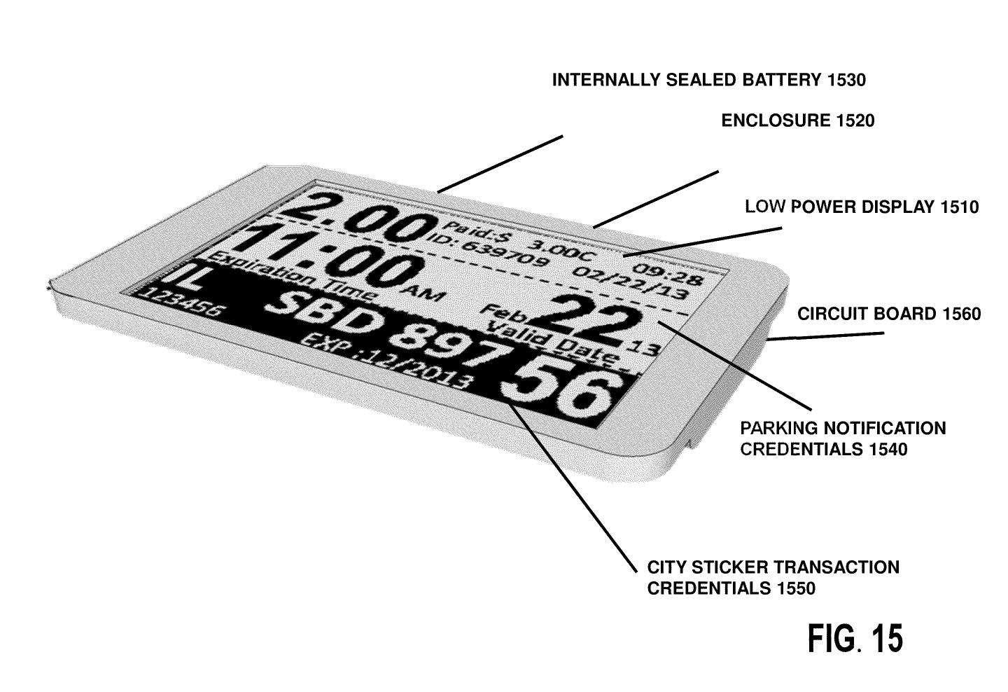

FIG. 15 illustrates a perspective view of an exemplary construction including housing and display of a token for a municipal parking system according to embodiments of the present inventions. A token here comprises a sealed enclosure consisting of essentially no buttons or keyboards for holding at least the antenna, the short-range RF receiver, the parsing circuit, the credentials memory, the notification circuit, the short-range RF transmitter, the power amplifier and the power source. In this embodiment a low power, E-ink display 1510, capable of withstanding environmental extremes, is used to visually convey the human readable subset of the transaction credentials. The battery 1530 may be of a non-rechargeable chemistry and internal to a factory sealed enclosure of the token. The display 1510 along with the circuit board 1560, battery 1530, antenna and other components are packaged together in an enclosure 1520 that can withstand the rigorous environmental conditions in the inside of a parked car.

Transaction credentials for a parking transaction received by the short-range RF receiver are chosen from the group of parking transaction context data that may consist of payment per hour, time, start time of parking session, duration of a parking session, end time of parking session, total payment, location of parking session, vehicle identity, transaction serial number identifier, and identity of the person/vehicle to whom the parking session is assigned.

The display 1510 is optionally segmented into two separate parts to allow one of the segments to be used to communicate the parking credentials 1540 and the other segment to communicate the credentials associated with the City or local municipality vehicle taxes 1550. In another embodiment, the display may be segmented into additional parts to notify additional credentials such as handicap permit and others. The data to be notified visually may contain start time and end time of the parking session, total payment, payment per unit time, location identifier and a unique transaction identifier.

In addition to the display, the notification credentials may be communicated via the short range RF technology. Current smartphones support the Bluetooth short range RF technology and for this reason in this embodiment the short range RF technology used initially will be Bluetooth Low Energy (BLE). BLE technology is chosen to facilitate the use of smartphones to manage transactions and also allow implementing the bridging relay functionality for communication of the parking transaction credentials to the token.

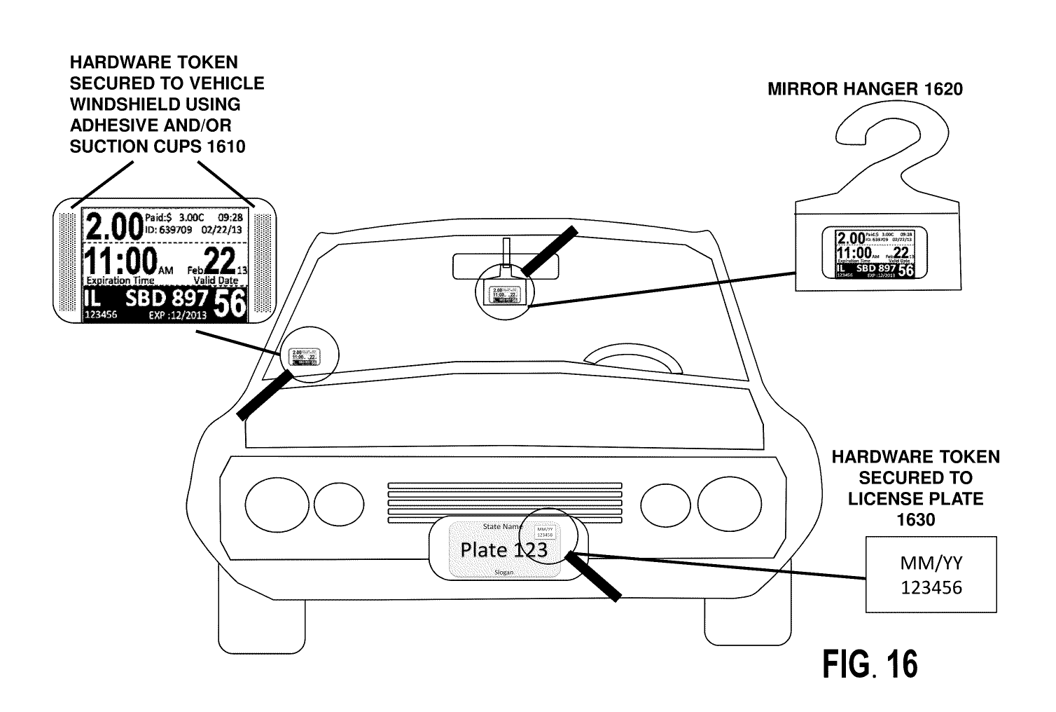

The token may also include a mechanism for attaching the token to the interior of the vehicle such that it is visible from the outside. The mechanisms to attach the token to the vehicle are illustrated in FIG. 16 and may include one or more of (i) micro suction cups 1610 to attach the token to the inside of the windshield, (ii) a hanger for attaching the token to the rear view mirror assembly 1620. Additionally and alternatively adhesive or removable hook and loop strips such as Velcro strips may be used. In an alternative embodiment, the token may be integrated with the vehicle electronics and into the vehicle's the communication bus, the sensor network, and battery system and the token may be integrated on the rear side of the rear view mirror.

FIG. 16 illustrates a view of an exemplary use of a token with a vehicle according to alternative embodiments of the present inventions. This embodiment is used to complete a license plate transaction, i.e., buy a new license plate or renew a license plate. The token in this embodiment contains a low power display 1630 coupled with a circuit board containing the short range RF and other needed circuitry. The said token is embedded in a suitable place (typically where the license plate renewal stickers are currently placed on the License plate.

Any signal processing techniques disclosed herein with reference to the accompanying drawings are preferably implemented on one or more digital signal processors (DSPs) or other microprocessors. Nevertheless, such techniques could instead be implemented wholly or partially as discrete components or hardwired circuits. Further, it is appreciated by those of skill in the art that certain well known digital processing techniques are mathematically equivalent to one another and can be represented in different ways depending on choice of implementation.

Any letter designations such as (a) or (b) etc. used to label steps of any of the method claims herein are step headers applied for reading convenience and are not to be used in interpreting an order or process sequence of claimed method steps. Any method claims that recite a particular order or process sequence will do so using the words of their text, not the letter designations.

Unless stated otherwise, terms such as “first” and “second” are used to arbitrarily distinguish between the elements such terms describe. Thus, these terms are not necessarily intended to indicate temporal or other prioritization of such elements.

Any trademarks listed herein are the property of their respective owners, and reference herein to such trademarks is generally intended to indicate the source of a particular product or service.

Although the inventions have been described and illustrated in the above description and drawings, it is understood that this description is by example only, and that numerous changes and modifications can be made by those skilled in the art without departing from the true spirit and scope of the inventions. Although the examples in the drawings depict only example constructions and embodiments, alternate embodiments are available given the teachings of the present patent disclosure. For example, although a parking transaction system is disclosed, the inventions are applicable to tolling systems, congestion charges, identification badges for employees and visitors, passports and visas, and loyalty cards, electronic wallets, and other similar transaction systems

What is claimed is:

1. A token, comprising:
an antenna;
a short-range RF receiver to receive wireless receive bursts comprising receive protocol overhead and transaction credentials operatively coupled to the antenna;
a parsing circuit operatively coupled to the receiver to receive the transaction credentials and to select a subset of the transaction credentials including a duration of an associated transaction;
a credentials memory operatively coupled to the parsing circuit to store and hold at least the subset of the transaction credentials for the duration of the transaction;
a notification circuit operatively coupled to the credentials memory to notify externally from the token a transaction notification indicative of the subset of the transaction credentials held in the credentials memory;
a short-range RF transmitter to transmit wireless transmit bursts comprising transmit protocol overhead and data;
a power amplifier operatively coupled to the short-range RF transmitter to power amplify the wireless transmit bursts to be transmitted by the transmitter; and
a power source operatively coupled to at least the power amplifier for powering at least the power amplifier and the short-range RF transmitter.

2. A token according to claim 1, wherein the short-range RF transmitter transmits the wireless transmit bursts in a burst data length shorter than a burst data length of the wireless receive bursts comprising the receive protocol overhead and the transaction credentials.

3. A token according to claim 2, wherein the data transmitted by the short-range RF transmitter comprises an acknowledgement notification sent after the short-range RF receiver receives each of the wireless receive bursts and an available notification sent when the short-range RF receiver is available.

4. A token according to claim 3,
wherein the wireless receive bursts received by the short-range RF receiver comprise control data; and
wherein the parsing circuit selects the subset of the transaction credentials based on instructions in the control data.

5. A token according to claim 3, wherein the parsing circuit generates a human readable subset of the transaction credentials.

6. A token according to claim 5,
wherein the token further comprises an externally facing display of a type having essentially zero power drain when an image on the display is static; and
wherein the notification circuit is operatively coupled to the externally facing display to command the externally facing display to visually hold the human readable subset of the transaction credentials.

7. A token according to claim 6, wherein the notification circuit is operatively coupled to the externally facing display to command the externally facing display to visually hold the human readable subset of the transaction credentials for the duration of the associated transaction.

8. A token according to claim 6, wherein the display is externally facing on a vehicle.

9. A token according to claim 8, wherein the display is attached to an inside surface visible through vehicle glass of the vehicle.

10. A token according to claim 8,
wherein the token further comprises a static vehicle plate; and
wherein the externally facing display is positioned within a portion of the static vehicle plate to display the transaction notification.

11. A token according to claim 6,
wherein the parsing circuit selects another subset of the transaction credentials including a duration of an associated transaction;
wherein the credentials memory stores and holds at least the another subset of the transaction credentials for the duration of the transaction;
wherein the notification circuit is operatively coupled to the credentials memory to notify externally from the token other transaction notifications indicative of the another subset of the transaction credentials held in the credentials memory;
wherein the notification circuit is operatively coupled to the short-range RF transmitter; and
wherein the data in the wireless transmit bursts transmitted by the short-range RF transmitter comprise the other transaction notifications.

12. A token according according to claim 1,
wherein the notification circuit is operatively coupled to the short-range RF transmitter; and
wherein the data in the wireless transmit bursts transmitted by the short-range RF transmitter comprise the transaction notifications.

13. A token according to claim 1, wherein the short-range RF transmitter is operatively coupled to the notification circuit to transmit wireless transmit bursts comprising the transaction notifications.

14. A token according to claim 13, wherein the short-range RF transmitter transmits the wireless transmit bursts comprising the transaction notifications more frequently than the receiver receives the wireless receive bursts.

15. A token according to claim 14, wherein the short-range RF transmitter transmits the wireless transmit bursts comprising the transaction notifications in a burst data length shorter than a burst data length of the wireless receive bursts.

16. A token according to claim 1,
wherein the token further comprises
a verification circuit operatively coupled to the short-range RF receiver and the credentials memory to receive the transaction credentials and to verify the transaction credentials; and
a key memory operatively coupled to the verification circuit to store the security information comprising a secure key and identity for decryption by the verification circuit to consummate securely; and
wherein the credentials memory stores and holds at least the subset of the transaction credentials upon validation by the verification circuit.

17. A token according to claim 1, wherein the power source comprises a battery internal to said token, wherein the battery is of a non-rechargeable chemistry and internal to a factory sealed enclosure of the token.

18. A token according to claim 1, further comprising sensors operatively coupled to the short-range RF transmitter to sense a detected physical state of the token to manage when the data is transmitted based on the detected physical state.

19. A token according to claim 1, wherein the transaction is from the group of licenses consisting of a municipal window sticker, vehicle license plate, handicap permit, and expectant mother license associated with the token.

20. A token according to claim 1,
wherein the parsing circuit selects the subset of the transaction credentials further including at least one of a start time and an end time; and
wherein the memory holds the subset of transaction credentials at least during the duration between at least one of the start time and end time.

21. A token according to claim 20, wherein the transaction credentials are associated with a parking session.

22. A token according to claim 1, further comprising sensors operatively coupled to the memory to determine at least one of the start time and the end time.

23. A token according to claim 1, wherein the short-range RF link is chosen from the group consisting of Bluetooth, Bluetooth Low Energy, WiFi, active RFID, Zigbee, and Zwave.

24. A token according to claim 1, wherein the transaction credentials received by the short-range RF receiver are chosen from the group of context data consisting of start time, duration, end time, price, location, transaction serial number identifier, and identity of an entity associated with the transaction.

25. A method for a token, comprising the steps of:
(a) receiving wireless receive bursts comprising receive protocol overhead and transaction credentials;
(b) parsing the transaction credentials received in said step (a) to select a subset of the transaction credentials including a duration of an associated transaction;
(c) holding at least the subset of the transaction credentials for the duration of the transaction;
(d) notifying externally from the token a transaction notification indicative of the subset of the transaction credentials held in step (c);
(e) transmitting wireless transmit bursts comprising transmit protocol overhead and data;
(f) power amplifying the wireless transmit bursts to be transmitted in said step (e); and
(g) providing power for the power amplifying of said step (f) and the transmitting of said step (e).

26. A token according to claim 25,
wherein said step (a) of receiving comprises the substep of (a)(1) receiving the wireless receive bursts comprising control data; and
wherein said step (b) of parsing comprises the substep of (b)(1) selecting the subset of the transaction credentials based on instructions in the control data.

27. A method for a token according to claim 25, wherein said step (e) of transmitting the wireless transmit bursts of data comprises the substep of (e)(1) transmitting the wireless transmit bursts in a burst data length shorter than a burst data length of the wireless receive bursts comprising the transaction credentials.

28. A method for a token according to claim 27, wherein said step (e) of transmitting the wireless transmit bursts comprises the substeps of
(e)(2) transmitting the wireless transmit bursts comprising an acknowledgement notification sent after the short-range RF receiver receives each of the wireless receive bursts; and
(e)(3) transmitting the wireless transmit bursts of data further comprising an available notification sent when the short-range RF receiver is available.

29. A method for a token according to claim 28, wherein said step (b) of parsing comprises the substep of (b)(1) generating a human readable subset of the transaction credentials.

30. A method for a token according to claim 28, wherein said step (d) of notifying externally comprises the substep of (d)(1) externally displaying the human readable subset of the transaction credentials generated in said step (b)(1).

31. A method for a token according to claim 29, wherein said step (d) of notifying externally further comprises the substep of (d)(2) visually holding external display of the human readable subset of the transaction credentials for the duration of the associated transaction.

32. A method for a token according to claim 30,
wherein said step (b) of parsing comprises the substep of (b)(1) selecting another subset of the transaction credentials including a duration of an associated transaction;
wherein said step (c) of holding comprises the substep of (c)(1) holding at least the another subset of the transaction credentials for the duration of the transaction;
wherein said step (d) of notifying comprises the substep of (d)(1) notifying externally from the token other transaction notifications indicative of the another subset of the transaction credentials held in the credentials memory; and
wherein said step (e) of transmitting comprises the substep of (e)(1) transmitting the data in the wireless transmit comprising the other transaction notifications.

33. A method for a token according to claim 25, wherein the data in the wireless transmit bursts transmitted in said step (e) comprise the transaction notifications.

34. A method for a token according to claim 33, wherein said steps (d) and (e) of notifying and transmitting further comprise transmitting the notifications comprising the subset of the transaction credentials more frequently than the said step (a) receives the receive wireless bursts.

35. A method for a token according to claim 34, wherein said step (d)(2) transmits the notifications comprising the subset of the transaction credentials in a burst data length shorter than a burst data length of the wireless receive bursts.

36. A method for a token according to claim 25,
wherein the method for the token further comprises the steps of
(h) verifying the transaction credentials using a stored secure key for decryption to consummate securely; and
(i) storing security information comprising a secure key and identity; and
wherein said step (c) of holding at least the subset of the transaction credentials comprises the substep of (c)(1) holding at least the subset of the transaction credentials upon verification by said step (g).

37. A method for a token according to claim 25, further comprising the step of
(h) sensing a detected physical state of the token; and
(i) managing when the data is transmitted based on the detected physical state.

38. A method for a token according to claim 25,
wherein said step (b) of parsing the transaction credentials further include the substep of (b)(1) selecting a subset of the transaction credentials further including at least one of a start time and an end time; and
wherein said step (c) of the holding the subset of transaction credentials for the duration of the transaction further comprises the substep of (c)(1) holding the subset of transaction credentials at least during the duration between the at least one of the start time and end time.

39. A method for a token according to claim 25,
wherein said method further comprises the steps of
(h) sensing a detected physical state of the token; and
(i) determining at least one of a start time and an end time based on the detected physical state; and
wherein said step (c) of the holding the subset of transaction credentials for the duration of the transaction further comprises the substep of
(c)(1) holding in the subset of transaction credentials at least one of the start time and end time determined in said step (i) after sensing; and
(c)(2) holding the subset of transaction credentials at least during the duration between the at least one of the start time and end time.

40. A method for a token according to claim 25, wherein the transaction credentials received in said step (a) are chosen from the group of context data consisting of start time, duration, end time, price, location, transaction serial number identifier, and identity of an entity associated with the transaction.
